(19) United States
(12) Patent Application Publication
(10) Pub. No.: US 2022/0316036 A1
(43) Pub. Date: Oct. 6, 2022

(54) SOFT MAGNETIC ALLOY AND MAGNETIC CORE

(71) Applicants: NIDEC CORPORATION, Kyoto (JP); TOKYO UNIVERSITY OF SCIENCE FOUNDATION, Tokyo (JP)

(72) Inventors: Shohei YOSHIDA, Kyoto (JP); Tomokazu FUKUZAKI, Kyoto (JP); Ryuji TAMURA, Tokyo (JP); Masataka SUGIYAMA, Tokyo (JP)

(21) Appl. No.: 17/642,204

(22) PCT Filed: Sep. 10, 2020
(86) PCT No.: PCT/JP2020/034347

§ 371 Date: Mar. 10, 2022

(30) Foreign Application Priority Data
Sep. 11, 2019 (JP) 2019-165486

(51) Int. Cl. C22C 38/00; H01F 1/147

(52) U.S. Cl. CPC C22C 38/002; H01F 1/147; C22C 2202/02

(57) ABSTRACT

A soft magnetic alloy containing 1% by atom or more and 10% by atom or less of one or more elements M1 selected from Ga and Ge, substantially containing no Si, and containing Fe and unavoidable impurities as a balance.

### CROSS-REFERENCE TO RELATED APPLICATIONS

This is the U.S. national stage of application No. PCT/JP2020/034347, filed on Sep. 10, 2020, and priority under 35 U.S.C. § 119 (a) and 35 U.S.C. § 365(b) is claimed from Japanese Patent Application No. 2019-165486, filed on Sep. 11, 2019.

### FIELD OF THE INVENTION

The present invention relates to a soft magnetic alloy and a magnetic core.

### BACKGROUND

Conventionally, an electromagnetic steel sheet of an Fe—Si-based alloy is known as a core of a motor or the like. The conventional electromagnetic steel sheet has a problem of poor workability, and there is known an electromagnetic steel sheet in which rolling is facilitated by adding Cr.

However, in the conventional electromagnetic steel sheet, it is difficult to form a three-dimensional shape by drawing. For example, it has been difficult to manufacture a cup-shaped rotor core, used for a rotor of an outer rotor type motor, by drawing.

### SUMMARY

According to one exemplary aspect of the present invention, there is provided a soft magnetic alloy containing 1% by atom or more and 10% by atom or less of one or more elements M1 selected from Ga and Ge, substantially containing no Si, and containing Fe and unavoidable impurities as a balance.

The above and other elements, features, steps, characteristics and advantages of the present disclosure will become more apparent from the following detailed description of the preferred embodiments with reference to the attached drawings.

### BRIEF DESCRIPTION OF THE DRAWING

FIG. 1 is a sectional view of an outer rotor type motor.

### DETAILED DESCRIPTION

Hereinafter, an embodiment of the present invention will be described with reference to the drawings.

A soft magnetic alloy of the present embodiment is represented by the general formula: Fe_{100-x-y}M1ₓM2_{y} (atom %). In the formula, M1 is one or more elements selected from Ga and Ge. M2 is one or more elements selected from Al, Mn, Ti, Cu, P, S, and Mo. x and y defining a composition ratio satisfy the ranges of 1≤x≤10 and 0≤y≤5, respectively. The balance other than the elements M1 and M2 consists of Fe and unavoidable impurities.

The soft magnetic alloy of the present embodiment is a crystalline soft magnetic alloy having a crystal structure in which the elements M1 and M2 are solid-solved in an Fe phase. With this configuration, both excellent magnetic characteristics and processability can be achieved. In the present embodiment, the elements M1 and M2 and unavoidable impurities are contained in a range in which amorphization does not substantially occur in the soft magnetic alloy.

The content of the element M1 is 1% by atom or more and 10% by atom or less in terms of the total content of Ga and Ge with respect to the entire soft magnetic alloy. By setting the content of the element M1 within the above range, it is possible to increase the electrical resistivity of the soft magnetic alloy while suppressing an increase in hardness of the soft magnetic alloy. As a result, a soft magnetic alloy having a small eddy current loss when the soft magnetic alloy is used as a magnetic core and also having excellent processability can be obtained.

More specifically, as will be described in Examples described later, according to the soft magnetic alloy of the present embodiment, an electrical resistivity of 0.40 μnm or more can be obtained. Vickers hardness can be suppressed to 145 HV or less.

Here, the eddy current loss flowing through the steel sheet is expressed by the following formula.

Pe=ke×(t·f·Bm)2/ρ (Formula 1)

In Formula 1, Pe represents an eddy current loss, ke represents a constant of proportionality, t represents a magnet width, f represents a frequency, Bm represents a maximum magnetic flux density, and ρ represents electrical resistivity.

That is, when the electrical resistivity of the steel sheet is doubled, the eddy current loss decreases to ½. Therefore, by providing a motor including a magnetic core using the soft magnetic alloy of the present embodiment, efficiency of the motor is improved.

Press drawing can be performed by setting the Vickers hardness to 145 HV or less. Therefore, according to the soft magnetic alloy of the present embodiment, a three-dimensional magnetic core such as a cup-shaped rotor core of an outer rotor type motor can be manufactured by drawing.

The motor including the rotor core formed from the soft magnetic alloy of the present embodiment has a small eddy current loss, is highly efficient, and can be manufactured inexpensively.

When the content of the element M1 is less than 1% by atom, resistivity of the soft magnetic alloy becomes a value almost close to that of pure iron, and therefore, the eddy current loss increases when the soft magnetic alloy is used as a magnetic core. When the content of the element M1 exceeds 10% by atom, it becomes difficult to obtain a homogeneous solid solution, and the processability tends to deteriorate. The content of the element M1 is preferably 5% by atom or less.

The element M2 is added to an Fe-M1 alloy as necessary. The content of the element M2 is 0% by atom or more and 5% by atom or less with respect to the entire soft magnetic alloy. By adding one or more elements M2 selected from Al, Mn, Ti, Cu, P, S, and Mo to the Fe-M1 alloy, it is possible to achieve both an increase in electrical resistivity of the soft magnetic alloy and suppression of hardness.

When the content of the element M2 is too small, it is difficult to obtain both the effect of increasing the electrical resistivity of the soft magnetic alloy and the effect of suppressing the hardness of the soft magnetic alloy. Thus, the content of the element M2 is preferably 0.5% by atom or more with respect to the entire soft magnetic alloy. When the content of the element M2 is too large, the electrical resistivity of the soft magnetic alloy decreases, and saturation magnetization of the soft magnetic alloy decreases. The content of the element M2 is preferably 4% by atom or less, more preferably 3% by atom or less with respect to the soft magnetic alloy.

In the soft magnetic alloy of the present embodiment, a total content of the element M1 and the element M2 is preferably 1% by atom or more and 5% by atom or less with respect to the entire soft magnetic alloy. By setting the total content of the elements M1 and M2 within the above range, the elements M1 and M2 can be easily solid-solved uniformly in Fe. This makes it possible to increase the electrical resistivity and the saturation magnetization of the soft magnetic alloy.

The soft magnetic alloy of the present embodiment does not substantially contain Si. That is, the soft magnetic alloy of the present embodiment does not contain Si at all or contains a trace amount of Si within a range in which the action and effect of the soft magnetic alloy of the present embodiment can be obtained. In the soft magnetic alloy of the present embodiment, when the Si content increases, the soft magnetic alloy becomes hard, and the processability deteriorates. Thus, it is difficult to manufacture a three-dimensional magnetic core such as a cup-shaped rotor core of an outer rotor type motor by drawing. A Si content in the soft magnetic alloy of the present embodiment is preferably 0.1% by atom or less, and it is more preferable that Si is not contained at all.

The soft magnetic alloy of the present embodiment preferably does not substantially contain Cr and Ni. As for Cr and Ni, when the content in the soft magnetic alloy increases, the soft magnetic alloy becomes hard, and the processability deteriorates. The Cr content and the Ni content in the soft magnetic alloy of the present embodiment are preferably within a range that does not impair the action and effect of the soft magnetic alloy of the present embodiment. Each of the Cr content and the Ni content in the soft magnetic alloy of the present embodiment is preferably 0.1% by atom, and it is more preferable that Cr and Ni are not contained at all.

The soft magnetic alloy of the present embodiment may contain a trace amount of carbon. When a C content in the soft magnetic alloy is too large, the soft magnetic alloy becomes hard, and the processability deteriorates; therefore, the C content is preferably 2% by atom or less, and more preferably 1% by atom or less with respect to the entire soft magnetic alloy.

Examples of unavoidable impurities in the soft magnetic alloy of the present embodiment include N, O, and H. The elements M2 and C having a content of less than 0.5% by atom can also be regarded as unavoidable impurities. The content of each unavoidable impurity is preferably 0.1% by atom or less. The total content of the unavoidable impurities is preferably 1% by atom or less with respect to the entire soft magnetic alloy.

### Examples

Using an arc melting furnace, 1.2 g of each of soft magnetic alloys having respective compositions of Examples 1 to 7 and Comparative Example 2 shown in Table 1 was prepared. The prepared soft magnetic alloy sample was cut into a plate piece having a size of 7 mm in length×0.5 mm in width×0.5 mm in thickness, and then the electric resistance at a temperature of 297 K was measured using a direct current 4-terminal method. For the magnetic properties, the soft magnetic alloy sample was cut into 2 mm square pieces, and a hysteresis curve of ±2 T was measured using a vibrating sample magnetometer (VSM). In the evaluation of the processability, the hardness of a soft magnetic alloy sample was measured using a Vickers hardness tester.

For Comparative Example 1 (iron aluminum alloy ALFE manufactured by Godai Inc.), Comparative Example 3 (electrogalvanized steel sheet in accordance with JIS G 3133), Comparative Example 4 (non-oriented electromagnetic steel sheet), and Comparative Example 5 (electromagnetic stainless steel), the same measurement as that of the soft magnetic alloy sample of Example was performed using a commercially available steel sheet.

Table 1 shows various properties of the prepared soft magnetic alloy and commercially available steel sheet.

TABLE 1

| | | Electrical | Vickers | Saturation |
|---|---|---|---|---|
| | Composition | resistivity | hardness | magnetization |
| | (at %) | (μΩm) | (HV) | (T) |
| Example 1 | Fe₉₅Ga₅ | 0.451 | 112 | 2.06 |
| Example 2 | Fe₉₅Ge₅ | 0.502 | 134 | 2.11 |
| Example 3 | Fe₉₅Ge₃Ga₂ | 0.490 | 131 | 2.19 |
| Example 4 | Fe₉₅Ge₄Al₁ | 0.461 | 127 | 2.01 |
| Example 5 | Fe₉₅Ge₃Al₂ | 0.452 | 121 | 2.05 |
| Example 6 | Fe₉₅Ge₂Al₃ | 0.482 | 121 | 2.11 |
| Example 7 | Fe₉₅Ge₁Al₄ | 0.446 | 113 | 2.13 |
| Comparative | Fe_{91.5}Al_{8.5} | 0.8 | 160 | 1.6 |
| Example 1 | (ALFE) | | | |
| Comparative | Fe₉₅Ge₃Si₂ | 0.494 | 147 | 2.09 |
| Example 2 | | | | |
| Comparative | Fe | 0.196 | 94 | 1.75 |
| Example 3 | (Electro- | | | |
| | galvanized | | | |
| | steel sheet) | | | |
| Comparative | Fe₉₇Si₃ | 0.280 | 177 | 1.70 |
| Example 4 | (Electro- | | | |
| | magnetic | | | |
| | steel sheet) | | | |
| Comparative | Fe₈₈Cr₁₂ | 0.600 | 171 | 1.20 |
| Example 5 | (Electro- | | | |
| | magnetic | | | |
| | stainless | | | |
| | steel) | | | |

As shown in Table 1, the soft magnetic alloys of Examples 1 to 7 all had a Vickers hardness of 145 HV or less, and had a hardness that allowed sufficient molding by drawing. The soft magnetic alloys of Examples 1 to 6 had an electrical resistivity 2 times and a saturation magnetization 1.2 times as large as those of the electrogalvanized steel sheet of Comparative Example 3. Therefore, by using the soft magnetic alloy of Examples 1 to 7, the cup-shaped rotor core of an outer rotor type permanent magnet motor can be manufactured by drawing, and a highly efficient permanent magnet motor can be manufactured at low cost.

The soft magnetic alloy of Comparative Example 2 to which Si was added together with Ge exhibited performance equal to or higher than that of Examples 1 to 7 in terms of the electrical resistivity and the saturation magnetization. However, the Vickers hardness was more than 145 HV, and processability adequate to allow for manufacturing a cup-shaped rotor core by drawing was not obtained. In the soft magnetic alloy containing one or more of Ge and Ga, it was confirmed that it was difficult to obtain desired processability by Si addition.

The soft magnetic alloy of Example 3 to which Ge and Ga were added in an amount of 5% by atom in terms of the total content and the soft magnetic alloy of Examples 4 to 7 to which Ge and Al were added in an amount of 5% by atom in terms of the total content had higher electrical resistivity than the soft magnetic alloy of Example 1 to which Ga was added and lower Vickers hardness than the soft magnetic alloy of Example 2 to which Ge was added, and both high electrical resistivity and high processability were achieved.

Examples 4 to 7 are evaluation results of a sample in which the total content of Ge and Al is fixed to 5% by atom and a ratio of Ge and Al is changed. In FeGeAl alloy of Examples 4 to 7, as the content of Ge was lower and a content ratio of Al was higher, the Vickers hardness was lower; however, the electrical resistivity and the saturation magnetization were substantially constant.

The commercially available Fe_{91.5}Al_{8.5} alloy of Comparative Example 1 containing no Ge exhibited higher processability than the electromagnetic steel sheet of Comparative Example 4 and the electromagnetic stainless steel of Comparative Example 5, but was inferior in both processability and saturation magnetization as compared with the soft magnetic alloy of Examples 1 to 7.

The soft magnetic alloy of the above embodiment can be suitably used for various magnetic cores and motors.

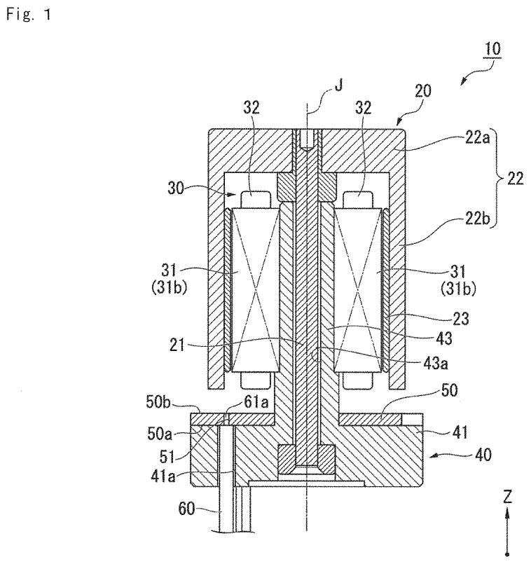

FIG. 1 is a sectional view illustrating an example of an outer rotor type motor. As illustrated in FIG. 1, a motor 10 includes a bracket 40, a rotor 20, a stator 30, and a circuit board 50.

The Z-axis direction illustrated in FIG. 1 is a vertical direction with the positive side defined as the “upper side” and the negative side defined as the “lower side”. A central axis J is an imaginary line that is parallel to the Z-axis direction and extends in the vertical direction. In the following description, a direction (vertical direction in the drawing) parallel to the central axis J of the motor 10 is simply referred to as an “axial direction”, a radial direction about the central axis J is simply referred to as the “radial direction”, and a circumferential direction about the central axis J, that is, a direction around the central axis J is simply referred to as the “circumferential direction” unless otherwise particularly stated.

The bracket 40 includes a circuit-board support portion 41 and a bearing part 43. In the present embodiment, the circuit-board support portion 41 and the bearing part 43 are parts of a single member. The circuit-board support portion 41 is in the shape of a plate having a plate surface orthogonal to the axial direction. The circuit-board support portion 41 has a circular shape about the central axis J as viewed along the axial direction.

The bearing part 43 has a tubular shape extending in the axial direction from a central portion of the circuit-board support portion 41. The bearing part 43 has a cylindrical shape about the central axis J, and is opened at its axially opposite sides. The stator 30 is held on the radially outer side of the bearing part 43.

The rotor 20 includes a shaft 21, a magnet holding portion 22, and a magnet 23. The shaft 21 is disposed along the central axis J. The shaft 21 has a columnar shape about the central axis J and extending in the axial direction. The shaft 21 is fitted in the bearing part 43. A gap is provided between an outer circumferential surface of the shaft 21 and an inner circumferential surface of the bearing part 43. The shaft 21 is supported by the bearing part 43 in a rotatable manner about the central axis J. An upper end portion of the shaft 21 protrudes upward from the bearing part 43. A lower end portion of the shaft 21 is supported from below by the bracket 40.

The magnet holding portion 22 is fixed to an upper end portion of the shaft 21. The magnet holding portion 22 includes a base portion 22a and a tubular portion 22b. The base portion 22a is fixed to the outer circumferential surface at the upper end portion of the shaft 21 and expands radially outward from the shaft 21. The base portion 22a covers an upper side of the stator 30. The tubular portion 22b is in a tubular shape extending downward from a radially outer circumferential edge of the base portion 22a. The tubular portion 22b is in a cylindrical shape about the central axis J. The magnet 23 is fixed to an inner circumferential surface of the tubular portion 22b.

The magnet holding portion 22 is formed from the soft magnetic alloy of the above embodiment. That is, the magnet holding portion 22 is a magnetic core and is a rotor core of the motor 10. The magnet holding portion 22 has a cup shape that opens downward. Since the soft magnetic alloy of the above embodiment is excellent in processability as compared with a conventional FeSi-based alloy electromagnetic steel sheet, the cup-shaped magnet holding portion 22 can be manufactured by, for example, drawing. Consequently, the magnet holding portion 22 can efficiently be manufactured at low cost. Since the soft magnetic alloy of the above embodiment can obtain high electrical resistivity equivalent to that of the electromagnetic steel sheet, the eddy current loss in the rotor 20 can be reduced, and the highly efficient motor 10 can be achieved.

The stator 30 is disposed above the circuit board 50. The stator 30 is arranged radially opposite to the rotor 20 with a gap therebetween. The stator 30 includes the stator core 31 and a plurality of coils 32. The stator core 31 is arranged so as to face on the inside of the magnet 23 in the radial direction with a gap interposed therebetween. A part or the whole of the stator core 31 may be manufactured using the soft magnetic alloy of the above embodiment.

The plurality of coils 32 are mounted on the stator core 31. Specifically, the coil 32 is formed by winding a coil wire around the tooth 31b of the stator 30. One end side of the coil 32 is electrically connected to the circuit board 50.

The circuit board 50 is in the shape of a plate having a plate surface orthogonal to the axial direction. The circuit board 50 is disposed below the stator 30. In the present embodiment, the circuit board 50 is disposed above the circuit-board support portion 41. Accordingly, the circuit-board support portion 41 is disposed between the stator 30 and the circuit board 50 in the axial direction. The circuit board 50 is fixed to the circuit-board support portion 41. Specifically, a lower surface 50a which is the lower surface of the circuit board 50 is fixed to an upper surface of the circuit-board support portion 41. A wiring pattern and each element (not illustrated) are provided on an upper surface 50b which is an upper surface of the circuit board 50. The wiring pattern and each element provided on the upper surface 50b of the circuit board 50 constitute, for example, an inverter circuit.

A lead cable 60 is connected to the circuit board 50. The lead cable 60 is, for example, a cable that supplies power and a control signal to the circuit board 50. The lead cable 60 has a metal terminal 61a at its tip. The metal terminal 61a is inserted into a through hole 51 vertically penetrating the circuit board 50. The metal terminal 61a is fixed to the circuit board 50 by solder or the like, and is electrically connected to wiring on the circuit board 50.

The embodiment described above is an example, and the structures can be modified or the like within a range not departing from the gist of the present invention. It is also possible to combine the constituent elements described in the above embodiment into a new embodiment. The matters described in the detailed description and the drawings may include constituent elements that are not essential for solving the problem.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A soft magnetic alloy containing 1% by atom or more and 10% by atom or less of one or more elements M1 selected from Ga and Ge, substantially containing no Si, and containing Fe and unavoidable impurities as a balance.

2. The soft magnetic alloy according to claim 1, containing 5% by atom or less of one or more elements M2 selected from Al, Mn, Ti, Cu, P, S, and Mo.

3. The soft magnetic alloy according to claim 2, wherein a total content of the element M1 and the element M2 is 1% by atom or more and 5% by atom or less.

4. The soft magnetic alloy according to claim 1, wherein a Si content is 0.1% by atom or less.

5. The soft magnetic alloy according to claim 1, substantially containing no Cr and Ni.

6. The soft magnetic alloy according to claim 5, wherein each of a Cr content and a Ni content is 0.1% by atom or less.

7. The soft magnetic alloy according to claim 1, wherein electrical resistivity is 0.45 μΩm or more.

8. The soft magnetic alloy according to claim 1, wherein Vickers hardness is 145 μΩm or less.

9. A magnetic core comprising the soft magnetic alloy according to claim 1.
